(19) United States
(12) Patent Application Publication
(10) Pub. No.: US 2026/0101113 A1
(43) Pub. Date: Apr. 9, 2026

(54) AUTOMOTIVE VIDEO CONVERSION SYSTEM AND METHOD

(71) Applicant: IDOSTREAM LLC, Manchester, CT (US)

(72) Inventor: Phong Ly, Tolland, CT (US)

(21) Appl. No.: 19/349,836

(22) Filed: Oct. 3, 2025

Related U.S. Application Data
(60) Provisional application No. 63/702,921, filed on Oct. 3, 2024.

(51) Int. Cl. H04N 23/698; H04N 7/18; H04N 23/63; H04N 23/81

(52) U.S. Cl. CPC H04N 23/698; H04N 7/185; H04N 23/631; H04N 23/81

(57) ABSTRACT

According to some embodiments, a system and method are provided to process videos to create motor vehicle advertising, the method comprises recording a video stream of a motor vehicle, determining a photograph of the motor vehicle to capture while recording the single video stream, and outputting the photograph, the video stream and a 360-degree spin of the motor vehicle created from the single video stream.

### BACKGROUND

Since the late 1990s, automotive dealerships have relied on static photos to merchandise (e.g., advertise) motor vehicles online. And, for the most part, they still do so today. Before video became a practical option, many dealers stitched photos together to create a slideshow presentation. Today, many automotive dealerships use one or two of the three advertising/merchandising forms (1) photos, (2) a walkaround video, and (3) a 360-degree spin to display vehicles online. Producing all three typically requires a photographer to shoot the vehicle three separate times using at least two cameras to capture photos, video, and the 360-degree spin in a multi-step process that takes at least 10 to 15 minutes. It would therefore be desirable to provide a system that does not require multiple cameras and multiple actions and which would also deliver multimedia content without delay for speed to market advantages and require less photographic equipment.

### SUMMARY

Some embodiments described herein relate to a system and a method to process videos to create motor vehicle advertising, the method comprises recording a video stream of a motor vehicle, determining a photograph of the motor vehicle to capture while recording the video stream, and outputting the photograph, the video stream and a 360-degree spin of the motor vehicle created from the video stream.

### BRIEF DESCRIPTION OF THE DRAWINGS

FIG. 1 illustrates a camera display in accordance with some embodiments.

FIG. 2 illustrates a method in accordance with some embodiments.

FIG. 3 illustrates a system according to some embodiments.

### DETAILED DESCRIPTION

In the following detailed description, numerous specific details are set forth in order to provide a thorough understanding of the embodiments. However, it will be understood by those of ordinary skill in the art that the embodiments may be practiced without these specific details. In other instances, well-known methods, procedures, components, and circuits have not been described in detail so as not to obscure the embodiments.

The present embodiments relate to a system and method associated with creating (1) photographs, (2) a walk around video and (3) a 360-degree spin associated with a particular motor vehicle (e.g., cars, boats, trucks, and motorcycles) based on recording a video stream of the particular motor vehicle. The video stream may comprise a single video or a stream of video(s). The term video may be considered synonymous with video stream for purposes of this application. In other words, one or more video clips may be combined into a single video. When a user records and snap photos while recording, the user can stop the recording and start another clip. For example, a clip may comprise doing a closeup of the headlight or tires and then pan out and start snapping photos again. The system and method described herein may automatically merge the clips together into one video stream and may also add in different types of fades, wipes, cuts between clips.

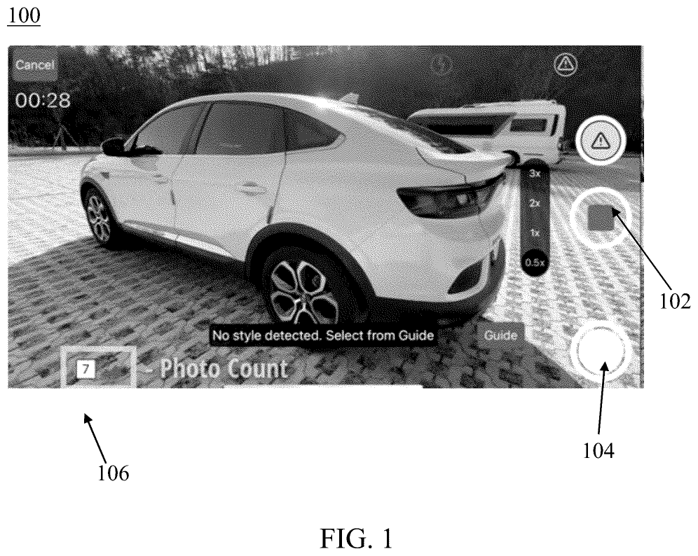

Now referring to FIG. 1, an embodiment of a camera display 100 is illustrated. As illustrated in FIG. 1, the camera display comprises a first touch screen control 102 for initiating the recording of a video and a second touch screen control 104 for taking individual photographs while taking the video. The camera display further 100 has a counter indicator 106 to keep track of a number of photographs and a number of video clips that have been taken.

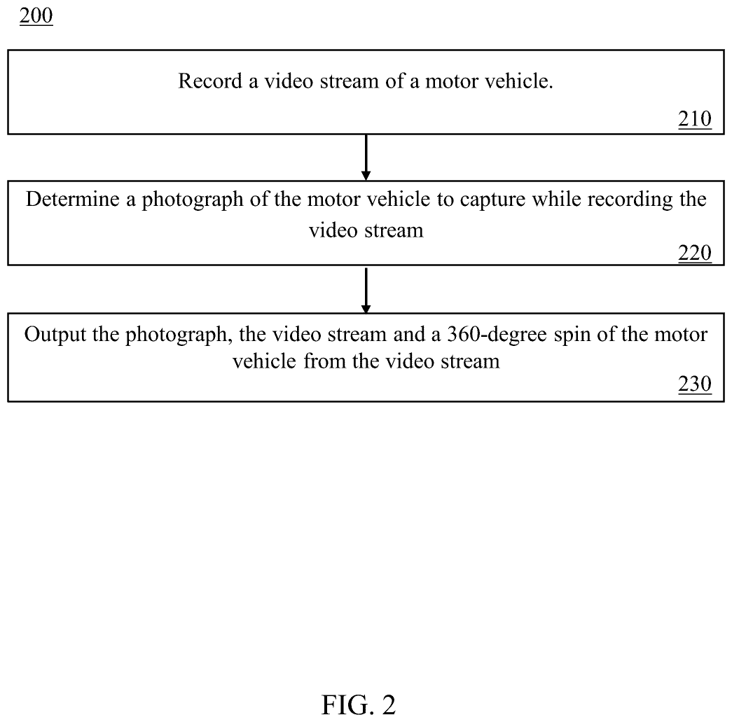

Now referring to FIG. 2, a method 200 that might be performed by a user using the camera display described with respect to FIG. 1. The method described herein does not imply a fixed order to the steps, and embodiments described herein may be practiced in any order that is practicable. Note that any of the methods described herein may be performed by hardware, software, or any combination of these approaches. For example, a non-transitory computer-readable storage medium may store thereon instructions that when executed by a machine result in performance according to any of the embodiments described herein.

Method 200 may relate to creating (1) photographs, (2) a video and (3) a 360-degree spin associated with a particular motor vehicle (e.g., cars, boats, trucks, and motorcycles) while recording a video of the particular motor vehicle. At 210, a video stream of a motor vehicle is recorded. Recording the video stream of a motor vehicle comprises a user walking around the motor vehicle while recording the video. This may be accomplished by taking one video in a single loop around the vehicle or by making multiple clips of the same vehicle during a single loop around the vehicle

For purposes of illustrating features of the present embodiments, some simple examples will now be introduced and referenced throughout the disclosure. Those skilled in the art will recognize that these examples are illustrative and are not limiting and are provided purely for explanatory purposes. In some embodiments, a car dealer will want to advertise a newly acquired used car. To advertise the used car, the car dealer will post photos of key features (e.g., dashboard, radio, wheels, trunk) as well as a 360-spin that lets a user move the image to see all sides of the used car. Therefore, to start the creation process, the user uses a cell phone running a specific application and walks around the used car to capture a video or multiple video clips of the used car.

Next, at 220, a photograph of the motor vehicle to capture while recording the single video stream is determined. In some embodiments, a 360-degree spin will also be created. In the present embodiments, a 360-degree spin refers generating the video in a format that allows a user to “scrub” the video forward and backwards by swiping with their finger or a mouse. In addition to capturing video and photos at the same time, in a single process, the present embodiment uses an interior and exterior vehicle video already captured during this process to generate the 360-degree spin automatically. Unlike other existing technology, the embodiments described herein generate the 360-degree spin without additional photography/videography, editing, or manual compilation of images, and does not require special 360 camera equipment. The recorded video content is simply converted into the 360-degree spin format by the extraction of hundreds of still images from the video in an automated process.

The 360-degree spin described herein produces an interactive interior and exterior viewer experience of a vehicle in a scrubbable format simulating spinning of the vehicle's exterior and scrubbing of the interior. Vehicle photos, walkaround video, and the 360-degree spin are all generated in a unified format for viewers using a multimedia player, to toggle easily back and forth between the 360-degree spin, walkaround video, and photos, in any order.

In some embodiments, determining a photograph comprises receiving an indication associated with the determined photograph from a user, capturing the determined photograph in response to the received indication, and storing the determined photograph. For example, and continuing with the above example, a user may have a list of photographs that are desired for advertising (e.g., tires, front bumper, windows, etc.). The user, as they are taking the video of the user card, may press/activate the second touch screen control 104 which may take photos, at the same time as the video is being recorded. The photos captured by pressing/activating the second touch screen control 104 may be stored in a separate directory from the recorded video.

In other embodiments, determining a photograph may comprise receiving a template comprised of predetermined features of the motor vehicle. These templates can be defined by dealerships as to which features of a vehicle they want to display on their website. For example, one dealership may be focused on the interior dash as they find their customers are more interested in the interior while another dealership may desire a focus on exterior features for their customer base. Based on the template of predetermined features, the system may extract the determined photograph (or photographs) from the video. For example, and continuing with the above example, in the present embodiment, after a video stream has been recorded, the system may analyze the recorded video stream for predetermined features. Analyzing the recorded video stream for predetermined features may entail having first trained the system to recognize specific features such as, but not limited to, a steering wheel, a radio, gauges, a shifter, etc. This system training may be comprised of providing feedback to the system through a series of recognition attempts and providing feedback to the system until it learns to recognize specific features of a motor vehicle (e.g. artificial intelligence).

The system may then automatically select a frame, or frames, from the video stream comprising the predetermined features. In this regard, the series of photos needed for the advertising may be automatically created from a recorded video. This saves storage space by having the system create the intended photos automatically instead of having a user manually take photos which are then stored and “weeded out” until the correct photographs are obtained. This also saves processor time from having to open, display and delete photos. Unlike conventional systems and methods that require using different devices where the recorded media are stored in each of one of the devices separately which takes up space in separate devices and it is time consuming to consolidate them into one place, the present embodiments may be accomplished using a single device. Moreover, the analyzing process may comprise analyzing the selected frame, or frames, for focus clarity. In other words, the system may be trained to detect the sharpest image in an available set of images for a particular predetermined feature. Images may be ranked, or compared to a pre-determined threshold of clarity and thus, when a focus clarity is above the pre-determined threshold of clarity, the extracted frame may be stored as the determined photograph. Also, in some embodiments, not only will the system, using artificial intelligence, be extracting a clear image but the image may be further processed (e.g., upscaling the photo) to sharpen it and make it more presentable for a website. In other words, the picture quality may be sharpened.

At 230, the photograph, the video stream and a 360-degree spin of the motor vehicle may be output the from the recorded video. The outputted images, the video, and 360-degree spin may be used in online advertising.

While the embodiments discussed above relate primarily to capturing exterior images of a motor vehicle, the same, or similar process, may be used to capture the interior of the motor vehicle. Using the same recording device, the photographer repeats the process described above to simultaneously capture video and photos of the interior of the vehicle. No additional camera equipment is required. The photographer simply selects a zoom lens setting (e.g., 1X) for capturing video and photos of the vehicle's interior. As the photographer moves into darker spaces within the vehicle's interior, lens sensors may compensate to maintain high-quality illumination for both video and photos.

In addition to capturing video and photos at the same time in a single process, a 360-degree spin of the interior may also be automatically created where the user can scrub the video back and forth, frame by frame (or every few frames) at a time to view the interior of the motor vehicle. The present embodiment creates an interactive interior and exterior viewer experience of a vehicle in a scrubbable format simulating spinning of the vehicle's exterior and scrubbing of the interior. Moreover, the photos, videos and 360-degree spin will be displayed on a dealer website on a multi-media player as soon as they're uploaded rather than having to be sent through a feed to a website provider.

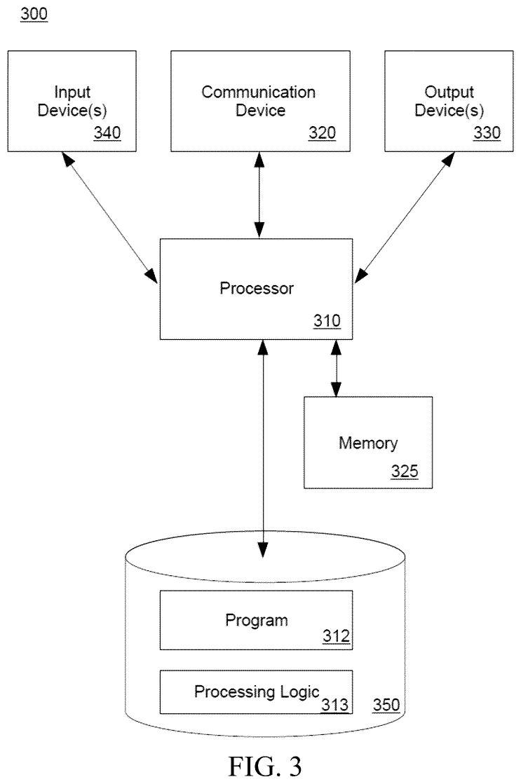

FIG. 3 illustrates a video system 300 for creating videos, photographs and a 360-degree spin that may be, for example, associated with camera display disclosed in FIG. 1. In some embodiments, the video system 300 may comprise a cell phone or a tablet device. The present system may provide a technical and commercial advantage by being able to create videos, photographs, and a 360-degree spin that does not require multiple cameras and multiple actions which also saves system storage space and require less photographic equipment.

The video system 300 may comprise a processor 310 (“processor”), such as one or more commercially available Central Processing Units (CPUs) in the form of one-chip microprocessors, coupled to a communication device 320 configured to communicate via a communication network (not shown in FIG. 3). The communication device 320 may be used to communicate, for example, with one or more computers or websites on a network. In some embodiments, the communication device 320 may comprise a network transmitter that may be a cellular transmitter, a Wi-Fi transmitter, a BLUETOOTH transmitter, or a wired network transmitter.

The video system 300 further includes an input device 340 (e.g., a mouse, touch pad, one or more cameras, and/or keyboard to enter or capture information about a motor vehicle) and an output device 330 (e.g., to output and display data and/or alerts) such as a display screen.

The processor 310 also communicates with a memory 325 and storage device 350 that stores data 313. The storage device 350 may comprise any appropriate information storage device, including combinations of magnetic storage devices (e.g., a hard disk drive), optical storage devices, mobile telephones, and/or semiconductor memory devices. The storage device 350 may store a program 312 and/or processing logic 313 for controlling the processor 310. The processor 310 performs instructions of the programs 312, 313, and thereby operates in accordance with any of the embodiments described herein. For example, the processor 310 may receive information associated with a motor vehicle and output photographs or a 360-degree spin via the instructions of the programs 312 and processing logic 313.

The programs 312, 313 may be stored in a compiled, compressed, uncompiled and/or encrypted format or a combination. The programs 312, 313 may furthermore include other program elements, such as an operating system, a database management system, and/or device drivers used by the processor 310 to interface with peripheral devices.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The process flow and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the elements depicted in the block diagrams and/or described herein. The method steps can then be carried out using the distinct software modules and/or sub-modules of the system, as described above, executing on one or more hardware processors. Further, a computer program product can include a computer-readable storage medium with code adapted to be implemented to carry out one or more method steps described herein, including the provision of the system with the distinct software modules.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, can be mixed and matched by one of ordinary skill in the art to construct additional embodiments and techniques in accordance with principles of this application.

Those in the art will appreciate that various adaptations and modifications of the above-described embodiments can be configured without departing from the scope and spirit of the claims. Therefore, it is to be understood that the claims may be practiced other than as specifically described herein.

What is claimed:

1. A method to process videos to create motor vehicle advertising, the method comprising:
recording a video stream of a motor vehicle;
determining a photograph of the motor vehicle to capture while recording the video stream; and
outputting the photograph, the video stream and a 360-degree spin of the motor vehicle from the video stream.

2. The method of claim 1, wherein recording the video stream of a motor vehicle comprises walking around the motor vehicle while recording the video stream.

3. The method of claim 2, wherein determining a photograph comprises:
receiving an indication associated with the determined photograph from a user;
capturing the determined photograph in response to the received indication; and
storing the determined photograph.

4. The method of claim 2, wherein determining a photograph comprises:
receiving a template comprising predetermined features of the motor vehicle;
extracting the determined photograph from the video stream based on the received template; and
storing the determined photograph.

5. The method of claim 4, wherein extracting the determined photograph comprises:
analyzing the video stream for predetermined features;
select a frame from the video stream comprising the predetermined features;
analyzing the selected frame for focus clarity; and
in a case that the focus clarity is above a pre-determined threshold, storing the extracted frame as the determined photograph.

6. The method of claim 5, wherein the extracted frame's picture quality is sharpened.

7. The method of claim 1, wherein the 360-degree spin is generated automatically from the recording a video stream such that a user can scrub the 360-degree spin forward and backwards by swiping.

8. A system comprising:
a processor; and
a non-transitory computer-readable medium comprising processor executable instructions, that when executed by the processor, performs a method, the method comprising:
recording a video stream of a motor vehicle;
determining a photograph of the motor vehicle to capture while recording the single video stream; and
outputting the photograph, the video stream and a 360-degree spin of the motor vehicle from the single video stream.

9. The system of claim 8, wherein recording the video stream of a motor vehicle comprises walking around the motor vehicle while recording the single video stream.

10. The system of claim 9, wherein determining a photograph comprises:
receiving an indication associated with the determined photograph from a user;
capturing the determined photograph in response to the received indication; and
storing the determined photograph.

11. The system of claim 9, wherein determining a photograph comprises:
receiving a template comprising predetermined features of the motor vehicle;
extracting the determined photograph from the video stream based on the received template; and
storing the determined photograph.

12. The system of claim 11, wherein extracting the determined photograph comprises:
analyzing the video stream for predetermined features;
select a frame from the video stream comprising the predetermined features;
analyzing the selected frame for focus clarity; and
in a case that the focus clarity is above a pre-determined threshold, storing the extracted frame as the determined photograph.

13. The system of claim 12, wherein the extracted frame's picture quality is sharpened.

14. A non-transitory computer-readable medium comprising processor executable instructions, that when executed by the processor, performs a method, the method comprising:
recording a video stream of a motor vehicle;
determining a photograph of the motor vehicle to capture while recording the single video stream; and
outputting the photograph, the video stream and a 360-degree spin of the motor vehicle from the single video stream.

15. The computer-readable medium of claim 11, wherein recording the video stream of a motor vehicle comprises walking around the motor vehicle while recording the single video stream.

16. The computer-readable medium of claim 12, wherein determining a photograph comprises:
receiving an indication associated with the determined photograph from a user;
capturing the determined photograph in response to the received indication; and
storing the determined photograph.

17. The computer-readable medium of claim 12, wherein determining a photograph comprises:
receiving a template comprising predetermined features of the motor vehicle;
extracting the determined photograph from the video stream based on the received template; and
storing the determined photograph.

18. The computer-readable medium of claim 12, wherein extracting the determined photograph comprises:
analyzing the video stream for predetermined features;
select a frame from the video stream comprising the predetermined features;
analyzing the selected frame for focus clarity; and
in a case that the focus clarity is above a pre-determined threshold, storing the extracted frame as the determined photograph.

19. The computer-readable medium of claim 18, wherein the extracted frame's picture quality is sharpened and wherein the 360-degree spin is generated automatically from the recording a video stream such that a user can scrub the 360-degree spin forward and backwards by swiping.
